(19) United States
(12) Patent Application Publication
(10) Pub. No.: US 2009/0274377 A1
(43) Pub. Date: Nov. 5, 2009

(54) Clustering System and Image Processing System Having the Same

(75) Inventors: Insoo Kweon, Ishikawa-ken (JP); Taketoshi Yoshida, Ishikawa-ken (JP)

Correspondence Address: KANESAKA BERNER AND PARTNERS LLP, 1700 DIAGONAL RD, SUITE 310, ALEXANDRIA, VA, 22314-2848, US

(73) Assignee: JAPAN ADVANCED INSTITUTE OF SCIENCE AND TECHNOLOGY, Nomi-shi (JP)

(21) Appl. No.: 12/084,847

(22) PCT Filed: Nov. 13, 2006
(86) PCT No.: PCT/JP2006/322584

§ 371 Date: May 12, 2008

(30) Foreign Application Priority Data
Nov. 11, 2005 (JP) 2005-328003

(51) Int. Cl. G06K 9/62

(52) U.S. Cl. 382/225

(57) ABSTRACT

[Subject] It is to provide a clustering system, the processing speed of which is high and which can perform clustering with high accuracy and to provide an image processing system having the clustering system.

[Means to Attain the Subject] A clustering system for classifying elements into clusters a plurality of times includes judging device. The judging device judges whether a cluster into which each element is classified is definite or indefinite at a predetermined timing between the classifications. After the predetermined timing, only the elements in the cluster judged as being indefinite by the judging device are classified. It is preferable that the classification before the predetermined timing is performed by the C-Means method and that the classification after the predetermined timing is performed by the FCM. An image processing system has the clustering system as a part of its functions and segments an image into regions by using the information on the clustered pixels.

### TECHNICAL FIELD

The present invention relates to a clustering system for classifying plural elements into plural clusters and particularly to an image processing system provided with an image clustering system for classifying pixels to segment an image.

### BACKGROUND ART

The clustering technology has heretofore been utilized as a technology for classifying plural elements into plural clusters based on some sort of index. The clustering technology comprises extracting feature quantities from the elements, mapping each element in a feature space and clustering the elements in consideration of the similarity of the feature quantities. For example, the C-Means (also called the C-Means method, the FCM (Fuzzy C-Means), etc. have been known as the nonhierarchical technique.

FIG. 23 is an explanatory view illustrating the C-Means method that is one example of the clustering technology and showing the state in which elements c1 to c10 are mapped in a feature space on the basis of their respective feature quantities. Assuming that clusters into which the elements are classified are called clusters A and B, the C-Means method comprises (1) first setting center values Ca and Cb of the clusters A and B randomly (FIG. 23(a)), (2) computing the distances between each of the elements c1 to c10 and the center values Ca and Cb and classifying the elements into the clusters A and B based on the computed distances closer to the center values (FIG. 23(b)), (3) computing the coordinate mean values of the elements classified into the clusters A and B and setting the mean values as fresh center values Ca and Cb (FIG. 23(c)), and (4) repeating (2) and (3) until the center values Ca and Cb show no change to complete the clustering (FIGS. 23(d) and 23(e)).

Furthermore, FIG. 24 is an explanatory view illustrating the FCM method that is another example of the clustering technology. The FCM method is a c-Means method incorporated into the fuzzy theory. The number of the clusters to which one element belongs is only one in the C-Means method (called the crisp division), whereas the FCM method shows the degree of each element belonging to the cluster based on its membership value to allow one element to belong to plural clusters (called the fuzzy division). That is to say, each element is classified into a given cluster based on its membership value.

To be specific, the FCM method comprises (1) first setting the center value of each cluster randomly, (2) computing the membership values of all the elements relative to the clusters to classify the elements into the clusters (computing the degrees of belongingness (ratios) to the clusters), (3) computing a new center value of every cluster, (4) repeating (2) and (3) until the center values show no change. As shown in FIG. 24, for example, weighting is performed using the ratio between the square of the distance from an element uₖ of a certain cluster i to the center Cᵢ of the cluster and the square of the distance from the element uₖ to the center Cⱼ of another cluster j. This weighting enables highly accurate clustering as compared with the C-Means method.

This clustering technology as incorporated into a computer system is applied to various fields including the region segmentation of images and the classification of text data. In the region segmentation of images, for example, the region segmentation is performed through the steps of processing the pixels within an image plane as elements, mapping as feature quantities data on the intensity, color and position of each images within a feature space, preparing clusters in which the pixels having similar features are brought together, and remapping the clusters in the image plane to obtain segmented images. Final regions in the image plane can be acquired through giving each pixel a label of the cluster to which the pixel belongs. In the case where MR imaging taken is segmented into vivi-sections as an example of image region segmentation, since the regions of the vivi-sections differ in intensity, the pixels are clustered, with the intensity as the feature quantity, to segment the pixels belonging to each cluster as pixels constituting each section. The following non-patent literature 1 discloses the technology on the region segmentation of the images by the clustering.

### Non-Patent Literature: “Adaptive Fuzzy Segmentation of Magnetic Resonance Images” Dzung L. Pham, Jerry L. Prince, IEEE TRANSACTIONS ON IMAGING, VOL. 18, NO. 9, SEPTEMBER 1999

### DISCLOSURE OF THE INVENTION

### Problems the Invention Intends to Solve

When the clustering technology incorporated into a computer system is utilized in various fields including image processing, however, the following problems will be posed. In the conventional clustering technology including the C-Means method and FCM method, the classification process shown in (2) above has to be performed a plurality of times until the center values show no change. All the elements are classified each and every time to increase the amount of throughput and prolong the processing time. Particularly, in the region segmentation of images using the clustering technology, since a great number of pixels constituting an image are classified, the influence of the above problems is great to allow the process to be prone to extend over a prolonged time period.

In addition, in the conventional C-Means method or FCM method, since the center value of each cluster is first set randomly, in case where the first value randomly set is far from the actual center value of the cluster, the number of processes repeated until the center values show no change becomes large to prevent a high-speed process from being realized. When the center value is set to be a minimal value (extremely biased value relative to the element), the process repeated many times will fail to make the center value appropriate, thereby possibly computing erroneous results.

Furthermore, in the conventional diagnostic imaging using medical images, it is the general procedure that an image diagnostician should perform a visual physical examination of medical images including MR imaging and transmit a checkup list to a doctor. In the present circumstances, however, it is difficult to notice a subtle change emerging in time series and make a comparison with another person. It is therefore conceivable to make a database of medical images and statistically process and standardize the medical images. In order to attain the database making, statistical process and standardization of the medical images, it is necessary to handle a great number of medical images. Thus, it is made indispensable to realize a high speed of image processing by a computer, particularly a high speed of region segmentation process frequently used for medical images. As described above, since the clustering technology is made use of for the region segmentation of the medical images, a high-speed clustering technology has strongly been demanded. In particular, MR imaging is composed of plural frame images obtained through continuous imaging of a living human body, with the positions of the cross sections thereof shifted. Recently, since the number of the frame images has a tendency to increase, a high-speed process is one of the most important subjects.

In view of the above, one object of the present invention is to provide a clustering system high in processing speed and capable of performing clustering with high accuracy and to provide an image processing system equipped with the clustering system.

### Means for Solving the Problems

The present invention provides a clustering system or method for clustering plural elements, comprising computing center values of clusters and distances between the center values of the clusters and the elements, performing plural classification processes for classifying the elements into relevant clusters based on the distances, wherein the clustering system or method includes a judging means or step for making judgments on whether the relevant clusters into which the elements have been classified are definite or indefinite at one or plural timings between adjacent classification processes and classifies only elements in clusters judged as being indefinite in the classification processes performed subsequent to the judgments.

All the elements have heretofore been classified each and every time the classification processes have been performed. According to the present invention, since the judging means makes judgments on whether the clusters into which elements have been classified are definite or indefinite and classifies only the elements in the clusters judged as being indefinite, it is made possible to decrease the amount of throughput and make the processing speed high as compared with the prior art in which all the elements are classified each and every time the classification processes are performed.

It is preferred that the classification processes performed before and after the judgment made by the judging means at the one timing or a final timing of the plural timings differ in processing method from each other. According to the present invention, a combination of the classification processes by the different processing methods enables clustering to be performed making use of the merits of the respective different processing methods as compared with the prior art performing the repeated classification processes by the same processing method.

It is preferred that the processing method for the classification process performed before the judgment made by the judging means at the one timing or a final timing of the plural timings has a smaller amount of throughput than that for the classification process performed after the judgment at that timing and that the latter processing method has higher accuracy than the former processing method. It is preferred, for example, that the former method is the C-Means method and that the latter method is the FCM method.

The elements possessing strong features of a cluster as being disposed near the center of the cluster have a tendency to be easy to classify. The elements possessing unclear features of the cluster as being disposed at the boundary of the clusters have a tendency to be difficult to classify. The present invention utilizes these tendencies and processes the feature-strong elements with a simple and high-speed classifying method and the feature-unclear elements with a highly accurately classifying method to make the processing speed high and maintain high clustering accuracy. For the initial classification process performed before the timing of judgment, a simple classifying method suppressed in amount of throughput (the C-Mean method, for example) is used. As a result, the elements easy to classify into clusters, i.e. the feature-strong elements, are classified into respective appropriate clusters. Therefore, the clusters into which these elements have been classified are judged as being definite at that timing. In the subsequent classification process, the feature-unclear elements, i.e. the elements whose clusters have been judged as being indefinite are classified using a method capable of high-accuracy classification process (the FCM method, for example). Consequently, it is made possible to make the processing speed high and maintain highly accurate clustering.

In the initial classification process based on the C-Means method, it is preferable to classify the elements into clusters so that the ratio of intercluster variance to intracluster variance may be maximal and set the mean value of the elements in each cluster as the center value of the cluster. According to the present invention, by classifying the elements into clusters in the initial classification process so that the ratio of intercluster variance to intracluster variance may be maximal, computing a mean value of the elements in each cluster and setting the mean value as a center value of the cluster to predict the center value of the cluster, it is made possible to approximate the predicted center value by the actual center value. As a result, it is possible to prevent an increase in computational effort and a misjudgment in clustering results, resulting from an inappropriate center value.

It is preferred that the judging means/step judges that a same cluster into which the elements are classified threshold times or more in the classification processes performed plural times before the judgment is definite and that other clusters are indefinite.

In the classification processes performed plural times, the elements classified frequently into the same cluster have a tendency to belong suitably to the cluster. The present invention utilizes this tendency and thus allows the judging means to judge that the same cluster into which the elements are classified threshold times or more in the classification processes performed plural times before the timing of the judgment by the judging means is definite and that other clusters are indefinite. Adjustment of the threshold enables the judgment accuracy to be heightened.

It is preferred that counting means is provided for counting the number of the elements classified into the same cluster as the cluster into which the elements are classified in a preceding classification process, that the judging means performs its judgment at a timing the counted number shows no change or decrease and that the judging means/step judges that the same cluster into which the elements are classified at that timing is definite and that other clusters are indefinite. In the case of counting the number of the elements classified into the same cluster in each classification process as the cluster into which the elements are classified in the preceding classification process and showing no change or a decrease in the counted number, the elements have a tendency to belong suitably to the very cluster. The present invention utilizes this tendency to judge the definiteness and indefiniteness with high accuracy.

The plural clusters are preferred to contain a cluster for noise. The elements clustered in the cluster for noise can be removed as noise to enable the clustering to be performed with high accuracy.

In equipping an image processing system/method with the clustering system/method, it is preferred that the elements are pixels constituting an image segmented, with the clusters as different regions. Specifically, in the image processing system equipped with the clustering system according to the present invention, the distance between each of the pixels constituting the image and the center value of each of the clusters is computed, and the classification process for classifying each pixel into a relevant cluster is performed repeatedly to cluster the pixels. The image processing system for segmenting the image, with the clusters as different regions, is provided with the judging means for deciding that each cluster of the pixels is definite or indefinite at one timing between the adjacent classification processes repeatedly performed or plural timings and, in the classification processes performed after the judgment by the judging means, only the pixels in the clusters judged by the judging means as being indefinite are classified.

It is particularly preferred that the images to be imaged are medical images having imaged the cross sections of a living human body and that the cluster is provided for every one section of the living human body. According to the present invention, it is made possible to segment the medical images. When applying the present invention to the medical images in consequence of taking the cross sectional images of a living human body including MR imaging, for example, every section of the medical images of the living human body can be segmented.

It is preferred that part of each region, in which more than the prescribed number of the pixels are not continuously arrayed after performing the region segmentation, is removed from the region. In the region segmentation of the image, one region is composed of a certain number of pixels, and a region composed of a small number of pixels has a tendency to constitute noise. The present invention utilizes this tendency and removes a part of each region, in which more than a prescribed number of pixels are not continuously arrayed, from the region to enable noise to be removed.

It is preferred that the image comprises plural images having spatial and temporal orders and that when more than a prescribed number of corresponding pixels are not continuously arrayed between adjacent images in each region after each image is segmented, the pixels are removed from the region. Here, the plural images having the spatial order are preferred to be frame images having continuously imaged cross sections, with the position displaced. Furthermore, the plural images having the temporal order are to be frame images having continuously imaged the same object to be imaged, with the time shifted.

Plural images constituting MR imaging and having the cross sections of the brain imaged with the position displaced, for example, have a spatial order in terms of imaged positions, whereas plural images constituting the MR imaging having the same position imaged with the time shifted have a temporal order. These images have mutually corresponding relationships in pixel. When these images have been segmented, a certain number of continuous pixels having the corresponding relationships between the images in each region have a tendency to belong to the same region. The other pixels have a tendency to constitute noise. The present invention utilizes these tendencies and, therefore, when more than a prescribed number of corresponding pixels between the images do not continuously exist in the same region, removes the relevant pixels from the region to enable removal of noise.

In addition, the clustering system of the present invention is preferably provided with output means for outputting the elements as segmented into each cluster. According to the present invention, it is possible to display the elements as segmented into the clusters and virtually confirm the clustering results. In the case of images, particularly medical images, the images can be seen in a state of being segmented.

### EFFECTS OF THE INVENTION

According to the clustering system of the present invention, since the judging means judges that the clusters into which the elements are classified are definite or indefinite and, after the classification process performed after the timing of judgment, only the elements in the clusters judged as being indefinite are subjected to classification process, it is made possible to reduce the amount of throughput and make the processing speed high as compared with the prior art repeating the classification process as regards all the elements until the clusters into which the elements are classified are judged as being definite.

Since the classification processes before and after the judgment by the judging means are performed using different processing methods, clustering can be performed making use of the merits of the respective different processing methods as compared with the prior art performing the repeated classification processes by the same processing method.

Particularly, by using as the processing method for the classification process performed before the judgment made by the judging means at the timing of judgment a processing method having a smaller amount of throughput than that for the classification process performed after the judgment at that timing and by using as the latter processing method a processing method having higher accuracy than the former processing method, it is made possible to make the processing speed high and maintain highly accurate clustering. The former method is a processing method based on the C-Means method and the latter method is a processing method based on the FCM method. Thus, the clusters of the elements having strong features are judged as being definite by the simple C-Means method and the clusters of the elements having unclear features judged as being indefinite by the C-Means method are judged as being definite by the FCM method, thereby attaining high-speed and highly accurate process.

In the case where the classification processes before the timing of judgment are performed by the C-Means method, a judging method utilizing the tendency of the C-Means method to classify elements into clusters is preferably used. That is to say, in the classification processes performed plural times before the timing of judgment, when the number of times the elements are classified into the same cluster is more than the threshold times, the cluster is judged as being definite, and the clusters of other elements are judged as being indefinite. As a result, the judgment in compliance with the C-Means method can be made to enhance the judgment reliability. The adjustment of the threshold enables the adjustment of the balance between high speed and reliability.

In addition, as the center value of each cluster of the initial clustering in the C-Means method and/or FCM method, a mean value of the elements in each cluster that have been classified into the clusters so that a ratio of intercluster variance to intracluster variance becomes maximal is regarded as a center value of each cluster. Since this enables the mean value to approximate the actual center value, it is made possible to prevent an increase in the amount of computation or lapsing into a minimal value resulting from an inappropriate center value.

Furthermore, when introducing a cluster for noise and noise-removing means, it will be made possible to further enhance the clustering accuracy while making the processing speed high.

While the present invention can be applied to various fields, the application thereof to images is particularly effective. The clustering process has heretofore been used in segmenting images into respective sections, and a high-speed clustering process will directly linked to a high-speed region segmentation process. Particularly, since the number of medical images to be processed is prone to an increase and since it is strongly demanded to make a database of medical images and statistically process and standardize the medical images, a high-speed region segmentation process is indispensable. From these points of view, therefore, the high-speed clustering process directly linked to the high-speed region segmentation process is very effective for image processing, particularly medical image processing.

### BEST MODE FOR CARRYING OUT THE INVENTION

### First Embodiment of the Invention

The clustering system and clustering method according to the first embodiment of the present invention are materialized using a computer system and premises the clustering technology including the C-Means method and FCM method, in which a classification process for classifying members into respective clusters on the basis of the similarity of the feature quantities is repeatedly performed plural times. The principle thereof lies in that it is judged at a prescribed timing between adjacent classification processes performed plural times whether a cluster into which elements are classified is definite or indefinite and that in the classification processes after that timing only the elements in the clusters that have been judged as being indefinite are subjected to classification process. The timing of judgment may be either once or plural times. While all elements have heretofore been classified every one classification process, since the present invention performs a classification process for only the elements in the clusters that have been judged as being indefinite at the timing of judgment, it is made possible to reduce the amount of throughput and make the processing speed high. One example of clustering system is equipped with plural classification processing means and judging means for judging the results classified. It may further include center value predicting means or noise-removing means (refer, for example, to reference numeral 100 in FIG. 11). When it is used as part of an image processing system, it may further include another noise-removing means (refer, for example, to reference numeral 200 in FIG. 11).

FIG. 1 is an explanatory view illustrating the principle of the present invention and showing the state in which elements c1 to c10 have been mapped in a feature space on the basis of their respective feature quantities. On the occasion of classifying the elements c1 to c10 into two clusters A and B, for example, it is judged whether the clusters are definite or indefinite at the timing the elements c1 to c10 have been subjected to classification processes some times. When it has been judged that the cluster A into which the elements c1 to c4 are classified is definite, that the cluster B into which the elements c5 to c8 are classified is also definite and that the clusters into which the elements c9 and c10 are indefinite (FIG. 1(a)), the clusters into which the elements c1 to c8 have been classified are decided to be definite and only the elements c9 and c10, the clusters of which have been judged as being indefinite, are again subjected to classification processes (FIG. 1(b)). The prior art has adopted the procedure comprising classifying all the elements c1 to c10 repeatedly until their clusters are judged as being definite without judging whether each of the clusters is definite or indefinite. In the present invention, each of the clusters is judged as being definite or indefinite and only the elements, the clusters of which are indefinite, are classified in the subsequent classification processes. Therefore, it is made possible to reduce the amount of throughput and make the processing speed high.

(Classifying Means)

The classifying means has functions of computing center values of the clusters and distances between the center values and the elements and performing plural times the classification processes for classifying the elements into the respective clusters. The first classifying means performs classification processes before the judgment made by the judging means and has a function of classifying all the elements plural times. The second classifying means performs classification processes after the judgment made by the judging means and has a function of classifying only the elements, the clusters have been judged as being indefinite by the judgment. The classifying methods of the classification processes performed before and after the timing of judgment on whether the clusters are definite or indefinite may be identical to or different from each other. For example, both the classification processes may be based on the C-Means method or FCM method. One of them may be based on the C-Means method and the other based on the FCM method. In addition, BCFCM (Bias-Corrected Fuzzy C-Means) method may be adopted. According to the BCFCM method, more accurate classification can be performed.

It is noted, however, that use of different classifying methods is preferred because the merits of the respective classifying methods can be utilized. It is particularly preferable to combine a simple classifying method performing high-speed classification processes while suppressing the amount of throughput with a highly accurate classifying method performing highly accurate classification processes through detailed computations. It is effective to classify the elements easy to classify into the relevant clusters using the simple classifying method and deliberately classify the remaining elements unclear to classify into the relevant clusters using the highly accurate classifying method in view of high-speed and highly accurate clustering.

The principle thereof will be described hereinafter. When a histogram in which the axis of ordinate stands for the number of elements and the axis of abscissas stands for the feature quantity has been produced with respect to the elements classified into three clusters (Class 0, Class 1 and Class 2) based on some sort of index, a bell curve shown in FIG. 2 is obtained. The bell curve has peaks identical in number to the clusters and forms a wave in which mountains identical in number to the clusters are continued. The mountains correspond to the clusters and the portions in the vicinity of the boundaries between the adjacent mountains correspond approximately to the boundaries between the adjacent clusters. Since the elements existing in regions X2 and X4 in the vicinity of the boundaries between the mountains have a possibility of belonging to the adjoining clusters and the clusters thereof are thus unclear, it is difficult to classify the elements. When the elements existing in regions X1, X3 and X5 have been studied, the elements near the peaks of the histogram conspicuously show the features of the clusters, and the elements near the opposite sides of the distribution (the opposite sides of the bell curve) can only be classified into one cluster, respectively. Thus, these elements are easy to classify into clear clusters.

Therefore, the elements existing in the regions X1, X3 and X5 and easy to classify into relatively clear clusters are subjected to a simple high-speed classification process, thereby judging the clusters of the elements at first, and only the elements existing in the regions X2 and X4 and classified into unclear clusters are deliberately classified using a highly accurate classification process. As a result, it is possible to maintain high accuracy while attaining a high speed. As the simple high-speed classifying method, for example, the C-Means method can be cited. As the highly accurate classifying method, for example, the FCM method can be cited.

(Judging Means)

Though various means are conceivable as the judging means for deciding whether the cluster of each element is definite or indefinite, any means may be adopted in accordance with the classifying method to be used and the features of the elements to be classified. When the classifying method is based on the C-Means method, for example, two means can be conceivable as shown below.

As described earlier, the C-Means method proceeds with the following procedure. It comprises mapping the elements in a feature space, (1) setting center values (mean values) of the clusters, (2) computing the distance between each of the elements and the center value to classify each element into a cluster to which the distance to the center value is shortest, (3) computing a fresh center value (the mean value of the clusters) from the results of the classification process, and (4) repeating (2) and (3).

First Judging Means:

In consequence of the classification process (2) performed plural times based on the C-Means method, the elements classified into the same cluster over the plural times have a fair probability that these elements belong appropriately to that cluster. It is supposed as shown in FIG. 3, for example, that elements c1 to c10 are classified into two clusters A and B (FIG. 3(a)). In consequence of the first classification process, the elements c1 to c4, c9 and c10 have been classified into the cluster A, and the elements c5 to c8 into the cluster B (FIG. 3(b)). Next, new center values Ca and Cb of the clusters A and B are computed (FIG. 3(c)) and the second classification process is then performed. As a result, it is assumed that the elements c1 to c4 have been classified into the cluster A, and the elements c5 to c10 into the cluster B (FIG. 3(d)).

When comparing the results of the first classification process (FIG. 3(b)) with the results of the second classification process (FIG. 3(d)), the elements c1 to c4 have been classified twice into the cluster A, and the elements c5 to c8 twice into the cluster B, and thus, there is no change in the kind of cluster. In this case, there is a fair probability that appropriately the elements c1 to c4 belong to the cluster A and the elements c5 to c8 to the cluster B. There is a fair probability that these elements are disposed in the regions X1, X3 and X4 near the peaks and opposite sides of the histogram shown in FIG. 2.

On the other hand, the elements c9 and c10 have been classified into the different clusters A and B one by one in the first and second classification processes. These clusters c9 and c10 are disposed in the boundaries between the adjacent clusters and have a tendency to make it unclear whether these elements belong to either of the two clusters. In the histogram of FIG. 2, there is a fair possibility that these elements are disposed in the regions X2 or X4 at the boundary.

The first judging means of the present embodiment utilizes the tendencies as described above. The judging means is initiated at a predetermined timing and judges that one cluster into which the elements are classified threshold times or more in the classification processes performed plural times before the timing of judgment by the judging means is decided to be definite and that the clusters into which the elements are classified less than the threshold times are decided to be indefinite. As a result, it is made possible to make judgments utilizing the aforementioned tendencies and enhance the reliability of the judged results. Either the procedure comprising increasing the number of classification processes and setting the threshold to be high, thereby enhancing the judgment accuracy or the procedure comprising decreasing the number of classification processes and setting the threshold to be low, thereby attaining higher-speed classification may be adopted.

Second Judging Means:

Different judging means is conceivable. The number of elements classified into the same cluster in the present and preceding classification processes in every set of classification processes is counted. The number of elements classified into the same cluster in the first classification process results (FIG. 3(b)) and the second classification process results (FIG. 3(d)) is eight. The judgment whether the clusters of the elements are definite or indefinite is made at the timing the counted number shows no change or decrease. When the third classification process (not shown) is performed to find that the number of elements classified into the same cluster as that in the second classification process is eight or less, it is judged at this time whether the clusters are definite or indefinite. When judging this, the cluster of the elements classified into the same cluster as in the preceding classification process is decided to be definite and the other clusters to be indefinite.

Third Judging Means:

Still different judging means is conceivable. When comparing the first classification process results (FIG. 3(b)) with the second classification process results (FIG. 3(f)), for example, the clusters of 8/10 of the total number of elements do not vary. Thus, in the case where the number of elements classified in the same clusters as those in the preceding classification process has been a prescribed number or more, the elements classified into the same clusters have a tendency to belong to the respective clusters. The third judging means utilizes this tendency, counts the number of elements classified in the same clusters as those in the immediately preceding classification process in every set of classification processes (2) and, when the number of elements classified into the same clusters as those in the immediately preceding classification process is the prescribed number or more, judges that the same clusters are definite and that other clusters are indefinite. Though the prescribed number may appropriately be determined, the results of the experiments reveal that the judgment can be made with high accuracy when the prescribed number is in the range of 9/10 to 19/20 or more of the entire number of elements.

(Center Value Predicting Means)

Though the initial center value of each cluster may randomly be set in the C-means method or FCM method, it is preferable to use center value predicting means for predicting the center value of each cluster.

FIG. 4 is an explanatory view illustrating the principle of predicting the center value. The principle puts the discriminant analysis method to practice and applies it to a multimode. It can be said that individual clusters are clearly separated when the variance of the elements in each cluster (hereinafter referred to as intracluster variance) is as small as possible and when the variance of the mean value in each cluster in the entirety (hereinafter referred to as intercluster variance) is as large as possible. Therefore, the center value predicting means acquires from Formula 1 a threshold of the feature amount making the ratio of the intercluster variance to the intracluster variance maximal, assumes that the threshold is the boundary of the clusters, computes the mean values of the individual clusters and decides each mean value to be the center value of each cluster.

The center value is predicted on the basis of the above principle as follows, for example. FIG. 5 is an explanatory view conceptually illustrating the predicting method. The amounts of features (here, exemplified as the intensity of pixels) are given thresholds, and the elements are classified into clusters so that the clusters may be separated with the thresholds. The number of the clusters is given in advance. The ratios of the intercluster variance to the intracluster variance are computed in respect of all cluster-separating patterns, with the thresholds (T₀, T₁, . . . Tᵢ) shifted, to acquire a cluster-separating pattern making the ratio maximal. The mean value of the elements of each cluster is obtained using the cluster-separating pattern and decided to be the center value of each cluster. The cluster-separating pattern making the ratio maximal, i.e. the thresholds (T₀, T₁, . . . Tᵢ) making the ratio maximal, is obtained from Formula 1 as below.

$${max}_{{t}_{i}} {( η = \frac{{σ}_{B}^{2}}{{σ}_{W}^{2}} )}_{i} {t}_{i} = {( {T}_{0} , {T}_{1} , … , {T}_{n} )}_{i} \\ {σ}_{B}^{2} = \frac{{\sum }_{i = 1}^{n} {{n}_{i} ( {μ}_{i} - {μ}_{T} )}^{2}}{{\sum }_{i = 1}^{n} {n}_{i}} {σ}_{W}^{2} = \frac{{\sum }_{i = 1}^{n} {n}_{i} {σ}_{i}^{2}}{{\sum }_{i = 1}^{n} {n}_{i}} \qquad [ Formula 1 ]$$

μᵢ: Mean of i-th cluster

nᵢ: Number of elements of i-th cluster

σᵢ: Variance of i-th cluster

σ_{W}²: Intracluster variance

σ_{B}² Intercluster variance

(Noise-Removing Means)

The elements may possibly contain noise. The present system is preferably equipped with noise-removing means. In the present invention, the noise removal is realized using three methods.

First Noise-Removing Means:

The first noise-removing means is added with one cluster for noise when classifying the elements into clusters to have a function to remove the noise. FIG. 6 is an explanatory view illustrating the principle thereof. When classifying the elements into three clusters, the histogram has a tendency to have four modes consisting of three modes (mountains of the histogram) and one noise mode. When classifying the elements into three clusters, besides the clusters 0, 1 and 2, the noise cluster 3 is provided. By removing the noise elements classified into the noise cluster, the accuracy of clustering can be enhanced.

When the clustering technology of the present invention is applied to an image, the second and third noise-removing means can be used. While the clustering technology of the present invention can be applied to various fields, the application thereof to an image is particularly effective. In such cases as the case of segmenting medical images including MR imaging into each section of a living human body, the image processing system equipped with the clustering system of the present invention is used. In the present image processing system, the pixels constituting the image are regarded as elements, and an image constituted by plural pixels is regarded as an element group. The mounted clustering system is used to subject the elements (pixels) into respective element groups (images), and the images are segmented, with the clusters as different regions. As shown in FIG. 7, for example, plural MR image imaged, with the position of the cross section of the living human body displaced, are constituted by plural frame images f, . . . , f. In order to segment one frame image f, the number of sections is made equal to the number of clusters, the pixels on every frame are classified into clusters, and the respective clusters are regarded as different regions. Thus, the frame images are segmented into sections. Here, the image mostly contains noise and, by removing the noise, the region segmentation can be performed with higher accuracy.

Second Noise-Removing Means:

The second noise-removing means is for removing noise from one frame image and, after the region segmentation of the image, has a function to remove part of the segmented region, in which more than the prescribed number of pixels are not arrayed continuously, from the region.

FIG. 8 is an explanatory view conceptually illustrating the second noise-removing means. The part of the region after being segmented having more than a prescribed number of pixels are not arrayed continuously tends to constitute noise. For example, when an image A is segmented to form pixels (0, 0), (0, 1), (1, 0), (1, 1) and (2, 2) as one region, while more than a prescribed number of pixels are arrayed continuously in the pixels (0, 0), (0, 1), (1, 0), (1, 1) that are parts of the region, the discontinuously arrayed pixel (2, 2) tends to constitute noise. By utilizing this tendency, the second noise-removing means removes the pixel (2, 2), for example, from the region to enables the noise to be removed from the region.

Third Noise-Removing Means:

Furthermore, in the case of plural images having a spatial or temporal order, each of the images is segmented and, when the corresponding pixels between the plural images do not exist in more than the prescribed number continuously in the same region, the pixels are removed from the region to thereby enable the noise to be removed from the region. As shown in FIG. 7, for example, the frame images f having a cross section imaged continuously, with the position shifted, have a spatial order, all the frame images are constituted by the same array of pixels, and the pixels between the frame images have a mutually corresponding relationship. When these frame images fare arrayed in the spatial order, each section of a living human body tends to continue between the frame images. Other images, such as the images of the physical object in time-series, animations, movies and images having a temporal order have the similar tendency. The third noise-removing means utilizes this tendency.

FIG. 9 is an explanatory view conceptually illustrating the third noise-removing means. Plural images A, B, C, D and E have a spatial or temporal order, each of the images A to E is constituted by pixels (0, 0) to (2, 2), and the pixels (0, 0) to (2, 2) have a mutually corresponding relationship among the images A to E. When these images A to E are segmented and arrayed in a spatial or temporal order, the pixels having the mutually corresponding relationship tend to belong to the same region in the form in which plural pixels are continuously arrayed. Here, the pixels (0, 0) belong to Class 0 in the images A, B, D and E, and the pixel (0, 0) only in the image C belongs to Class 1. The remaining pixels belong to the same Classes in all the images A to E. The pixel (0, 0) in the image C is discontinuous and has a fair possibility of constituting noise in Class 1. Therefore, the third noise-removing means has a function to array the segmented images in a specific order, compares the pixels having a mutually corresponding relationship and remove from a specific region, as noise, a pixel not continuous a prescribed times within the specific region. As a result, the accuracy of the region segmentation of the image can be enhanced.

As a concrete method of implementing the second and third noise-removing means, the two-dimensional or three-dimensional labeling technology is used. The two-dimensional labeling technology is as follows. An image is binarized every one Class. As regards the binarized image, one of the two values is used to give the same label to the continuous images to perform the region segmentation. On this occasion, it is preferable to perform 4-neighbor or 8-neighbor connected component labeling. The part in which pixels of the same label are not arrayed continuously in more than the prescribed number within the region is removed from the region. In addition, the 3D labeling technology performs the same labeling relative to the corresponding pixels between the images besides the two-dimensional labeling and prefers to perform 6-neighbor, 18-neighbor or 26-neighbor connected component labeling.

### Second Embodiment

An image processing system 200 equipped with a clustering system 100 will be described hereinafter as the second embodiment. The clustering system 100 is designed, with the clustering system of the preceding embodiment as the fundamental one, to suit image processing. The image processing system 200 is equipped as part of its function with the clustering system 100 and performs image processing using the results of clustering by the clustering system. In the present embodiment, cited as an example is the case where images constituting MR imaging of the brain that are medical images are used as object data and where the pixels in every frame image are clustered to perform the region segmentation into cerebrospinal fluid, gray matter and white matter.

FIG. 10 is a block diagram showing the configuration of the image processing system 200 equipped with the clustering system 100. The image processing system 200 equipped with the clustering system 100 has an inside bus 11 to which a communication interface 12, a CPU 13, a ROM 14, a RAM 15, a display 16 and a keyboard/mouth 17, a drive 18 and a hard disc 19 are connected to transmit address signals, control signals, data, etc., thereby constituting the configuration of the image processing system 200.

The communication interface 12 has a function to connect to the communication network including the Internet, for example, and makes it possible to download programs for permitting a computer to function as the system of the present invention and receive object chemical images. The CPU 13 has a function to control the entire apparatus using the OS stored in the ROM 14 and performs processes based on various kinds of application programs stored in the hard disc 19.

ROM 14 stores therein programs for controlling the entire apparatus, such as the OS, and has a function to supply these programs to the CPU 13. The RAM 15 has a memory function utilized as a work area when the CPU executes the various kinds of programs.

The display 16 has a function to display menus, statuses, display transitions, images, etc. The keyboard/mouse 17 has a function to input data including letters, numerals, symbols, etc. and indicate cursor or point locations and enables various data to be input.

The drive 18 is a drive unit for executing the installation operation from recording medium, such as CDs and DVDs, having various kinds of programs and data recorded therein and enables a program for permitting a computer to function as the present system to be installed from a recording medium and object data to be input.

The hard disc 19 is a memory having memorized therein a program 19a, a memory 19b and object data 19c. The program 19a corresponds to a memory having memorized the program installed from the communication interface 12, drive 18, etc. in an executable format. The memory 19b constitutes a memory part for saving files of the results of execution of various programs.

The object data 19c is a data file in which data read via the communication interface 12 and drive 18 are stored. The object data 19c comprises MR imaging (sectioned images) of the head imaged continuously, with the position thereof shifted, as shown in FIG. 7, for example. The MR imaging comprises a plurality (here, 124 pieces) of continuous frame images f . . . , f Each of the frame images f . . . , f comprises plural pixels. In the clustering, the pixels correspond to the elements, and the frame images f . . . , f correspond to the element groups. In the present embodiment, by clustering the pixels (elements) of the frame image if the frame image is segmented into cerebrospinal fluid, gray matter and white matter. Since the cerebrospinal fluid, gray matter and white matter tend to have different intensity values, by clustering the pixels with the intensity values used as feature quantities, the region segmentation can be performed.

FIG. 11 is a block diagram functionally illustrating the present embodiment. The clustering system 100 is equipped with center value predicting means 101, first classifying means 102, classification result judging means 103, second classifying means 104 and first noise-removing means 105a. The image processing system 200 is equipped as part of its function with the clustering system 100 and further equipped with second noise-removing means 105b, third noise-removing means 105c, input means and output means.

The input means is means for inputting the object data 19c, such as a drive or scanner for a recording medium. It may also be an interface for connection to an apparatus for producing object data, such as an MR apparatus. While the input means may be provided integrally as part of the present system, it may be disposed at a distant place from the present system 200 and connected thereto via a network. While the number of clusters may be set beforehand within the system, it may be set through a user from the input means, such as the keyboard/mouse.

The center value predicting means 101 has a function to predict the initial center value of each cluster in the classification process by the first classifying means. The center value predicting means 101 makes an analysis on the basis of the discriminant analysis method, classifies the pixels into clusters so that the ratio of intercluster variance to intracluster variance may be maximal and decides the mean value of each cluster to be the first center value of each cluster. To be specific, it computes the threshold of each cluster using Formula 1, then obtain the mean value of intensity values of the pixels belonging to each cluster and decide the mean value to be the center value of each cluster.

The first classifying means 102 has a function to perform the classification process before the timing of the judgment made by the judging means. While the first classifying means 102 may perform the classification process based on any of the classifying methods, it prefers to be based on the C-Means method. In this case, the following processes are performed with respect to every frame image, which comprises (1) setting as initial center values the center values calculated by the center value predicting means 101, (2) computing the distance between each pixel and each center value and classifying each pixel into a cluster disposed nearest to the pixel, (3) computing new center values and (4) repeating the processes (2) and (3) until the set timing. The number of repetitions of (2) and (3) is set to be two. It may be three or more. In addition, the counting means is provided for counting the number of the elements classified into the same cluster as the cluster into which the elements are classified in the preceding classification process every plural times of the classification process (2) performed with the first classifying means 101. The timing may be set so that the classification processes by the first classifying means 101 may be terminated when the number counted by the counting means shows no change or a decrease.

The judging means 103 has a function to judge whether the clusters to which the respective pixels belong are definite or indefinite at the prescribed timing. The timing is in advance determined. At that timing, in view of the results of the processes by the first classifying means, it is decided that the clusters to which the respective elements belong are definite or indefinite. The criterion for judgment on the definiteness or indefiniteness has been stored in advance in the clustering system 100.

For example, the criterion for judgment lies in that it is judged that the same clusters into which the pixels are classified more times than the threshold in consequence of plural times of the classification process (2) by the first classifying means 101 are judged to be definite and that other different clusters to which the elements belong are judged to be indefinite. In the present embodiment, it is decided that the same clusters into which the pixels have been classified twice in consequence of the two times of the classification process (2) by the first classifying means 101 are judged to be definite and that the clusters of the other pixels (the pixels that have been classified into different clusters twice) are judged to be indefinite. The repetition of the classification process may be three times or more, and the three times or more of the threshold may be adopted. For example, it is made possible to enhance the accuracy of the judging results by setting the number of repetition of the classification process to be three or more times and setting the threshold to be three times or more. By increasing the number of repetition of the classification process and heightening the threshold, it is possible to enhance the judging results. The amount of throughput can be reduced through reduction in the number of the repetition of the classification process and through setting the threshold value low.

Another judging means 103 may adopt a criterion for judgment different from the aforementioned criterion. For example, the counting means is provided for counting the number of the pixels classified into the same cluster as the cluster into which the pixels are classified in the preceding classification process, with every classification process (2) performed with the first classifying means 101 as plural classification processes. The classification processes by the first classifying means 101 are terminated when the number counted by the counting means shows no change or a decrease. At the time of termination of the classification processes by the first classifying means 101, the judging means 103 judges that the same clusters as the clusters into which the pixels are classified in the preceding classification process are definite and that other clusters of the pixels are indefinite.

The judging means 103 may make a judgment based on a criterion different from the aforementioned criterion. For example, the classification process (2) by classifying means 101 is repeated until the number of pixels classified into the same clusters as those in the preceding classification process (i.e. the pixels, the clusters of which are not changed) becomes more than the prescribed number. The judging means 103 makes a judgment at the timing of the termination of each classification process (2). The judging means 103 judges that the same clusters as the clusters into which the pixels are classified in the preceding classification process (i.e., the clusters of the pixels are not changed) are definite and that other clusters of the pixels are indefinite. In this case, the threshold of the pixels making the cluster change nil is preferably in the range of 9/10 to 19/20 or more of the entire number of elements.

The second classifying means 104 has a function to perform classification processes after the timing of the judgment by the judging means 103. While the second classifying means may perform classification processes based on any of classifying methods, it preferably performs the classification processes based on the FCM method. In this case, the procedure thereof comprises (1) setting the center value of each cluster randomly and computing the number N of the pixels whose clusters are judged as being definite and a mean value A of the feature quantities (intensity values), (2) computing the membership values of all the elements relative to the clusters judged by the judging means 103 as being indefinite, (3) computing a new center value of each cluster from the N elements having the mean value A and the elements whose clusters are judged as being indefinite, (4) repeating (2) and (3) until the center values show no change. When the membership values are real numbers from 1 to 0, it is noted that the membership value of the pixels whose clusters are judged, by the judging means 103, as being definite is 1 and that the membership value of the pixels of other clusters is 0.

While the noise-removing means 105 comprises three noise-removing means 105a, 105b and 105c, one or all of them may be adopted. The second noise-removing means 105b has a function to remove a part of each segmented region, in which more than the prescribed number of pixels are not arrayed continuously, from the region segmented in every section after every cluster classification of the pixels with respect to each frame image f having the pixels classified by the clustering system 100. The third noise-removing means has three functions, i.e. a function to array the frame images f in the order of the positions at which images have been taken, a function to compare the pixels of the adjacent frame images within each region and, when more than the prescribed number of the corresponding pixels between the imageries do not exist continuously within the same region, and a function to remove the pixels from the region.

To be concrete, the second noise-removing means 105a produces a binary image per class with respect to each frame image f. The binary image is produced through the steps of giving a threshold to the membership value of the pixels relative to each cluster and binarizing the pixels within and outside the threshold range. When removing noise depending on the array of the pixels within the frame image f, labeling is performed relative to every binary image to perform region segmentation. The pixels, the same labels of which are not continuous in more than the prescribed number within the region, are removed from the region (the membership value relative to the region is set to be 0). When using the third noise-removing means 105b to remove noise depending on the array of the pixels between the frame images f, the procedure comprises disposing the binary images in the order of the positions at which imaging has been performed, performing the labeling in the imaging direction and removing from the region part in which the pixels, the same label of which is not continuous in more than the prescribed number. In the case of removing noise in the three-dimensional direction, 3D labeling is performed to remove the pixels from the region, the same label of which is not continuous in more than the prescribed number. In this way, the pixels not continuously belonging to the same region (cluster) in more than the prescribed number are removed from the region, thereby removing the noise.

The first noise-removing means 105a has a function to increase one cluster as a cluster for noise. While one or both of the first classifying means 102 and the second classifying means 104 may perform classification into three clusters for cerebrospinal fluid, gray matter and white matter, it is preferred that adoption of the first noise-removing means 105a increases the number of clusters by one for noise and that classification into four clusters including the cluster for noise is adopted. The noise is absorbed into the noise cluster and consequently it is possible to eliminate the noise from the three other clusters to establish enhanced accuracy.

The output means is means for outputting the results of classification and is a display or a printer, for example. The output means may either be provided as an integral part of the present system or disposed separately of the present system 100 and connected via a network to the present system.

Here, the first classifying means 102 and the second classifying means 104 will suffice insofar as they can perform plural times the process for classifying the elements into relevant clusters and the high-speed effect of the present invention even when the classifying methods adopted by the two classifying means 102 and 104 are the same. However, it is preferable to adopt different classifying methods for the two classifying means as described above because the merits of the two different classifying methods can be leveraged. Particularly, when the first classifying means 102 is based on the C-Means method and the second classifying means 104 is based on the FCM, the clustering accuracy can highly be maintained, with the high speed attained.

Furthermore, the center value predicting means 101 may be omitted. In this case, in the first classification process, a random value is set as the initial center value. Preferably, however, the center value predicting means 101 is provided because predication of the center value can prevent an increase of the number of computation and an error in the clustering results.

Moreover, the noise-removing means 105 may be omitted. In this case, at the time of the termination of the process by the second classifying means 104, the image having each pixel classified into the relevant cluster is output as the process results.

(Description of Operation)

Next, the operation of the image processing system 200 equipped with the clustering system according to the present embodiment will be described. FIG. 12 is a flowchart illustrating the operation of the present system.

At first, images constituting MR imaging are input (step S1). The MR imaging of the present embodiment consists of 124 frame images f, and the present system reads all the frame images f, acquires data on the intensity values of the pixels and the number of pixels having each intensity value and subjects the data to process steps S2 to S5. Since all the frame images are regarded as objects to be processed, a larger number of elements can be used as samples to enhance the accuracy of the process the steps S2 to S5. FIG. 13(a) shows an example of a histogram of the intensity and the number of pixels of one frame image and FIG. 13(b) shows an example of a histogram of the total intensity of the 124 frame images and the number of pixels. FIG. 13(b) compared with FIG. 13(a) shows the smooth histogram, making it possible to suppress the effect of noise.

Then, the center value predicting means 101 computes the initial center value of each cluster (step 2). For example, it computes as the center value thresholds (T₀, T₁, . . . , Tᵢ) of the feature quantities for classifying clusters so that the ratio of the intercluster variance to the intracluster variance may be made maximal. The computed thresholds (T₀, T₁, . . . , Tᵢ) are used to classify the pixels into clusters, and the mean value of the intensity values of the pixels of each cluster is set as the center value of each cluster.

Next, the first classifying means 102 classifies the pixels into clusters, with the intensity degrees as the feature quantities (step S3).

FIG. 14 is an explanatory view illustrating the step S3 in detail. The values computed in the step S3 are first set as the center values of the respective clusters (step S31). The initial value 0 is assigned to a counter (step S32). Incidentally, this counter is for counting the number of repetition of the classification process performed at the present step. The counter i is added with 1 (step S33). The distance between each pixel and each center value of the clusters is computed, and each pixel is classified into a cluster having the center value closest in distance to the pixel (step 34). The classified results (pixels and classified clusters) linked with i are stored as accumulated (step 35). A new center value of each cluster is computed from the classified results (step 36). It is judged whether the new center value is changed (step 37). The classifying process is terminated in the case of no change in center value. In the case of a change in center value, it is judged whether i=N (N being a prescribed number) (step S38). When i=N is unsatisfied, the procedure is returned to the step 33. When i=N is satisfied, the classification process is terminated. As a result of the present step S3, data on the respective clusters into which the pixels are classified are obtained. Incidentally, since the pixels of the same intensity value have the same distance to the center value of a cluster, they are classified into the same cluster.

Subsequently, the judging means 103 judges whether a cluster of each pixel is definite or indefinite (step S4). The method of judgment on whether the cluster is definite or definite lies in the following procedure, for example. With reference to the data (classified results) stored as accumulated, it is judged that the number of times each pixel has been classified into a specific cluster is the threshold or more. When the number of times is the threshold or more, the clusters are decided to be definite and, when the number of times is less than the threshold, the clusters are decided to be indefinite.

Incidentally, when the different judging means is used, it may be set to have a function suitable for the judging method of the first classifying means or the judging means. When the different judging means is employed, the counting means counts in each of the classification processes the number of pixels that has been classified into the same cluster as that in the preceding classification process and, at the timing the number shows no change or a decrease, the first classification process is terminated. Then, the judging means judges if a pixel in images is a cluster-definite element or a cluster-indefinite element: one being a cluster-definite element if it is the same cluster as its cluster in the preceding classification process, and the other being a cluster-indefinite element if not. In addition, when the different judging means is used, the classifying means terminates the classification process at the timing the number of the pixels classified into the same clusters as that in the preceding classifying process, and the judging means judges that the same cluster into which the pixels are classified is decided to be definite and that other clusters are decided to be indefinite.

Next, the second classification means performs the classifying process with respect only to the elements whose clusters are decided by the judging means to be indefinite (step S5). FIG. 15 is a flowchart illustrating the step S5 in detail. Referring to the results of the step S4 (step S51), both the number K of the pixels, each cluster of which has been decided to be definite, and the mean value A of the feature quantities (intensity values) are obtained (step 52). New center values are computed from the pixels whose clusters are decided to be definite and indefinite Here, the number K of the pixels, each cluster of which has been decided to be definite, the mean value A of the intensity values and the intensity values of the elements whose clusters are decided to be indefinite are used to compute a mean value of the intensity values and decide the mean value a new center value. In consequence thereof, it is judged whether the new center value shows a change. When there is a change, the procedure is returned to the step S53 and, when there is no change, the procedure is terminated. Real numbers from 0 to 1 are given as membership values. The membership value of the pixels, the clusters of which are judged as being definite in the judging step S4, is 1 and that the membership value of the pixels of other clusters is 0. As a result, the data on the membership value of each cluster relative to each cluster can be obtained.

The image of each cluster per frame image is produced based on the membership value (step S6). FIG. 16 shows a diagram having visualized the image data produced. A single frame image f is separated into clusters for cerebrospinal fluid, gray matter, white matter and noise, thus producing four image data. To be concrete, the elements on one frame image are classified into clusters based on the data of each pixel and its membership value obtained in the step S5. As shown in FIG. 17, the intensity values corresponding to the membership values of the pixels relative to the relevant clusters are determined, and the determined intensity values are decided to be the intensity values of the pixels corresponding to the relevant clusters. The intensity value of each cluster is obtained using a product of the membership value of the cluster and the level number of intensity. In FIG. 17, the intensity level is 256.

Next, the noise removal by the noise-removing means is performed (step S7). The present step is taken using the 3D labeling technology. The present step is taken like the following procedure. A binary image of each cluster per frame image is produced. When the image divided into regions as shown in FIG. 16 has already been obtained, the regions may be binarized using a prescribed threshold (within and outside the range of the predetermined threshold). As regards the binary images, the 3D labeling is performed to remove a part of each region in which the same label is not continuous in more than a prescribed number from the region, with the membership value of the cluster corresponding to the region given 0. FIG. 18 is a diagram having visualized the pixels judged as noise by the step S7. The pixels blue-colored, yellowish green-colored and yellow-colored are the pixels judged as noise. The intensity values of these images are made identical with the intensity value of the background to remove the noise.

Next, image data are displayed on demand of a user with reference to the image data produced in step S7. FIG. 19 is a diagram of the image data displayed. In this example, the image segmented into cerebrospinal fluid, gray matter and white matter per frame image is displayed. The designation of a frame image may display the images of the three clusters, otherwise, the designation of a region of the frame image may display only the image in the corresponding region of the corresponding frame image and, alternately, the designation of a region may successively display the images in the corresponding regions of all the frame images. Thus, various ways to display the image can be adopted as occasion demands.

### Third Embodiment

FIG. 20 is a schematic block diagram functionally showing an image processing system 210 equipped with a clustering system 110 according to the third embodiment. The same means as that in the second embodiment are given the same reference numerals, and the description thereof will be omitted.

FIG. 21 is a flowchart illustrating the movement of the image processing system 210. The clustering system 110 performs plural times the judgment by the judging means 103 during the classification process. The classifying means starting after the judgment by the judging means 103 comprises plural second and third classifying means, and selecting means 106 has a function to appropriately select a classifying means starting after the judgment by the judging means 103.

FIG. 22 a flowchart illustrating the movement of third classifying means 107. The third classifying means 107 has a function to perform the classification process based on the C-Mean method with respect to only the elements whose clusters have been judged as being indefinite by the judging means 103. The procedure thereof comprises (1) referring to the classified results of the classification process performed most recently and the results of judgment made by the judging means 103 most recently, (2) computing the distance between each element whose cluster has been judged as being indefinite in consequence of the judgment made by the judging means 103 most recently and the center value (mean value of the clusters), classifying each element into the cluster having the center value closest to each element and retaining intact the pixels whose clusters have been judged as being definite, (3) computing the center value of the cluster again and (4) repeating (2) and (3). The conditions of the repetition may be the same as those in the second embodiment.

The selecting means 106 selects a subsequent classification process based on a predetermined criterion. In the present embodiment, it selects the second or third classifying means. The criterion may include the steps of counting the number of the third classification processes, for example, and selecting the third classifying process when the counted number is not less than the threshold or the second classifying process when the counted number is less than the threshold. Otherwise, it may include the steps of counting the number of pixels classified into the same clusters as those in the preceding classification process and selecting the third classification process when the counted number is less than the threshold or the second classification process when the counted number is not less than the threshold. Alternatively, it may include the steps of selecting the third classification process when the number of the pixels whose clusters are judged to be definite is not less than the threshold or the second classification process when the number is less than the threshold. In the case of providing other classifying means, criteria for appropriately selecting them may be provided.

According to the system of the present embodiment, also in the classification process based on the C-Means method, only the elements (pixels) whose clusters are indefinite are subjected to a classification process. Thus, further reduction in amount of throughput and higher processing speed can be attained.

Incidentally, the second embodiment has been described exemplifying the FCM method as the subsequent process of the judging means, and the third embodiment has been described exemplifying the C-Means and FCM methods. However, the KFCM (Kernel Fuzzy C-Means) method may be adopted instead. The KFCM method comprises arraying all the frame images f, . . . , f within a three-dimensional space (a space, with the x-axis and y-axis as the longitudinal and lateral pixel arrays, respectively, of the frame images and the z-axis as the array of the frame images f . . . , f in the cross-sectional order, adding intensity value data to each pixel and carrying out the segmentation using four-dimensional data including the date in the three-dimensional space of the pixel arrays and the data of the intensity values. This enables the segmentation, with both the morphological pixel distribution (spatial pixel distribution) and the intensity used as the parameters. For example, only the elements whose clusters have been judged to be indefinite may be subjected to the KFCM method after the judgment by the judging means and the results may be output. Furthermore, the results of the KFCM method may be judged by the judging means, only the elements whose clusters have been judged to be indefinite may be subjected to segmentation again by the FCM method using the intensity as the parameter. The use of the FCM method after the KFCM method enables the accuracy to be further enhanced.

Incidentally, while the embodiments of the present invention have been described as exemplifying the region segmentation of medical images (brain MR imaging), they may be applied to region segmentation of images marked with characters into the characters and the background for the purpose of character recognition, region segmentation of images for examination in a production line of industrial products with the aim of part search or faulty part examination and other region segmentation of various images. Besides, the present invention can widely be adopted insofar as elements are classified into plural clusters.

### BRIEF DESCRIPTION OF THE DRAWINGS

FIG. 1 It is an explanatory view illustrating the principle of the present invention.

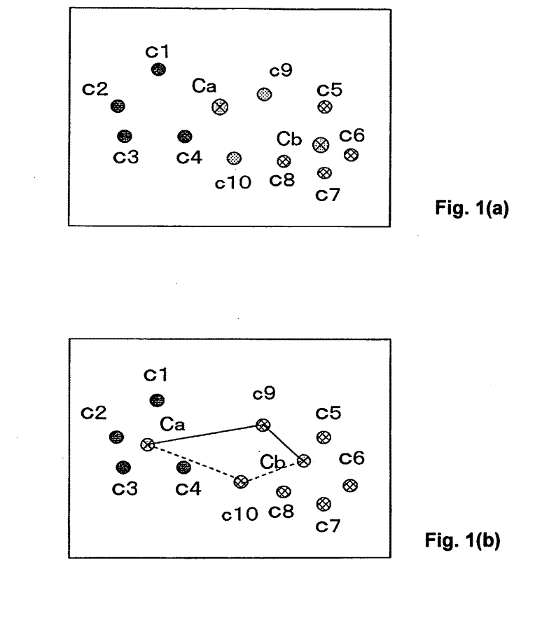

FIG. 2 It is a histogram in which the axis of ordinate stands for the number of pixels and the abscissa axis for the feature quantity.

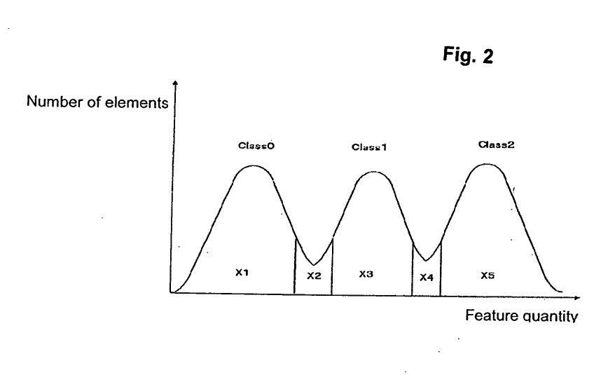

FIG. 3 It is an explanatory view illustrating the principle of the judging method of the present invention for judging that the cluster is definite or indefinite.

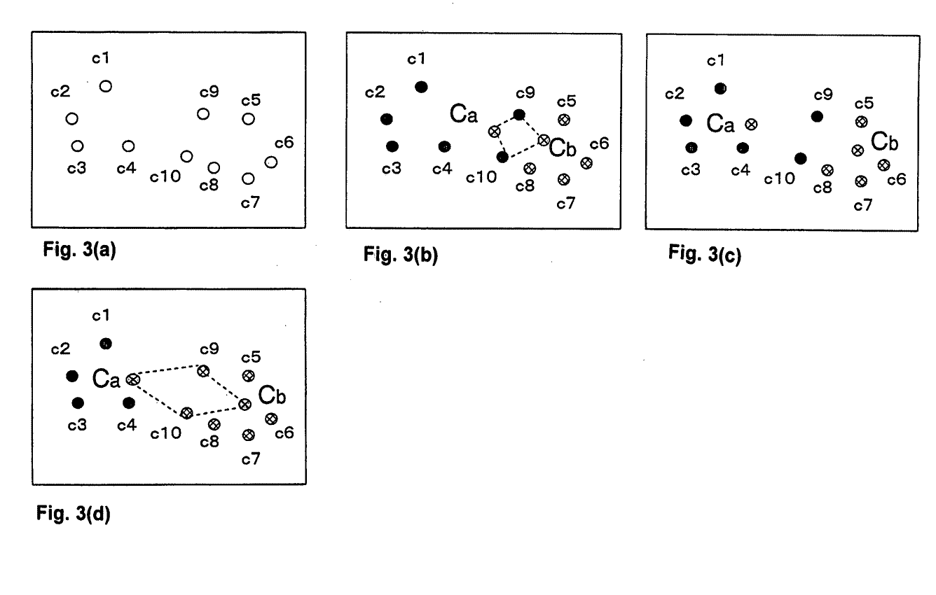

FIG. 4 It is an explanatory view illustrating the principle of predicting the center value according to the present invention.

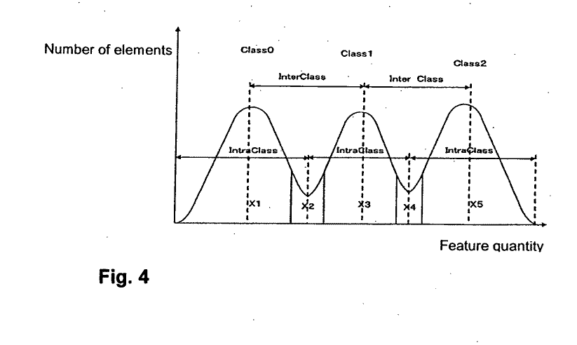

FIG. 5 It is an explanatory view conceptually illustrating the principle of the predicting method of the present invention.

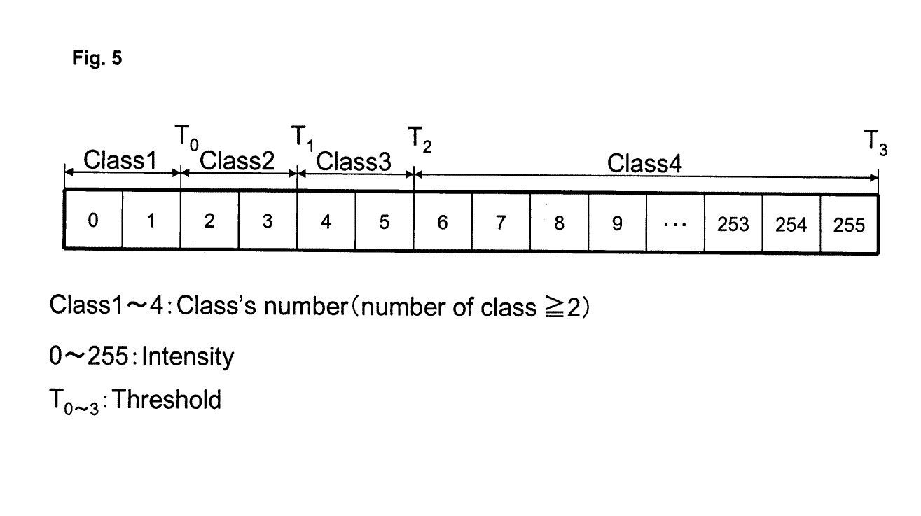

FIG. 6 It is an explanatory view illustrating the principle of the first noise-removing method of the present invention.

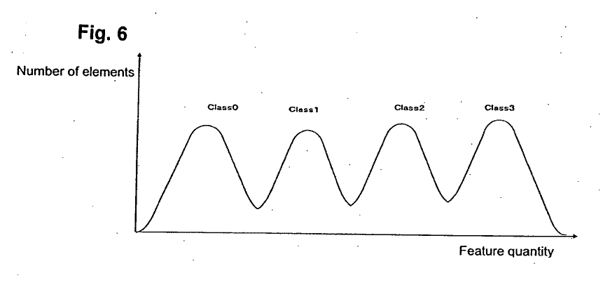

FIG. 7 It shows an example of plural images constituting MR imaging obtained by taking the cross sections of a living human body, with the position thereof displaced.

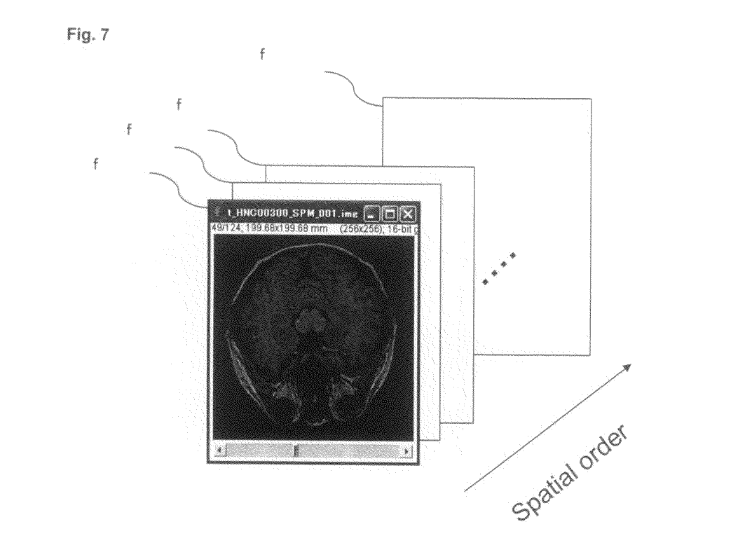

FIG. 8 It is an explanatory view illustrating the principle of the second noise-removing method of the present invention.

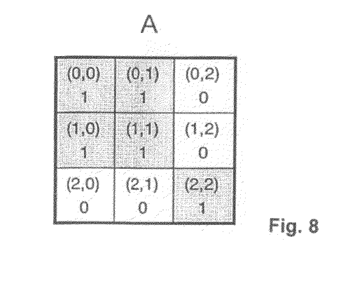

FIG. 9 It is an explanatory view illustrating the principle of the second noise-removing method of the present invention.

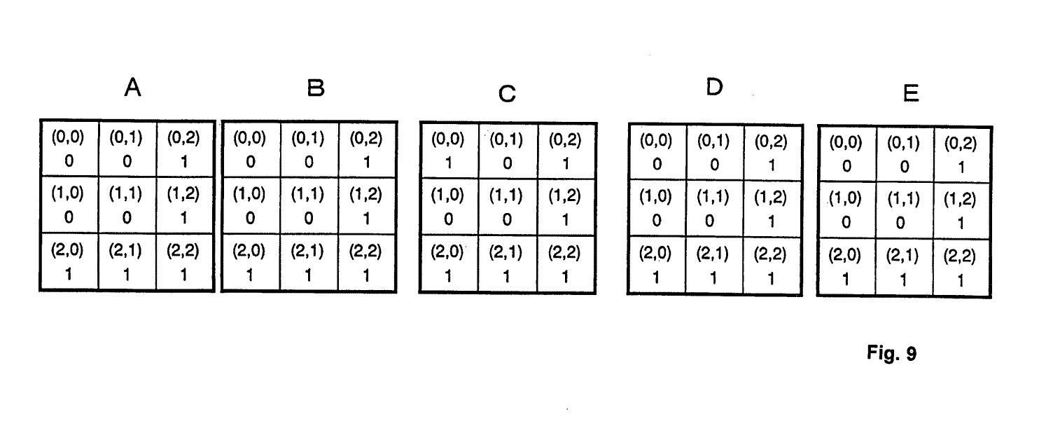

FIG. 10 It is a block diagram showing the configuration of the clustering system according to one embodiment of the present invention.

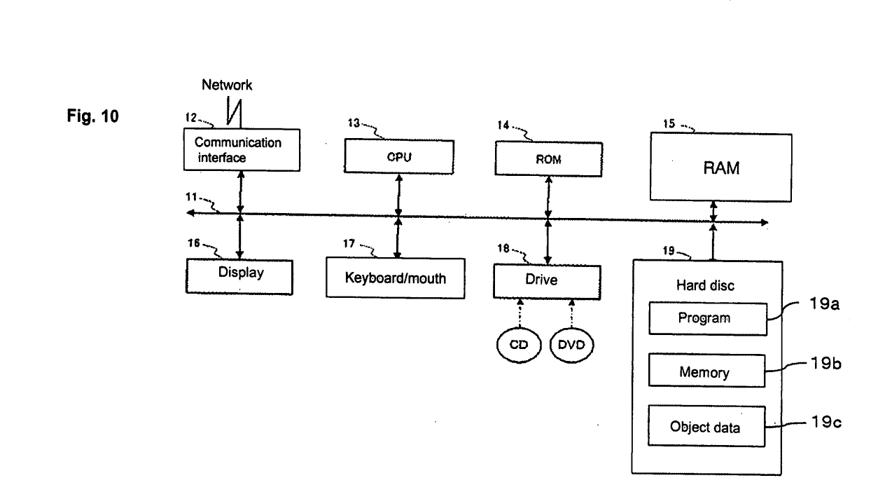

FIG. 11 It is a block diagram showing the functions of the clustering system in the above embodiment.

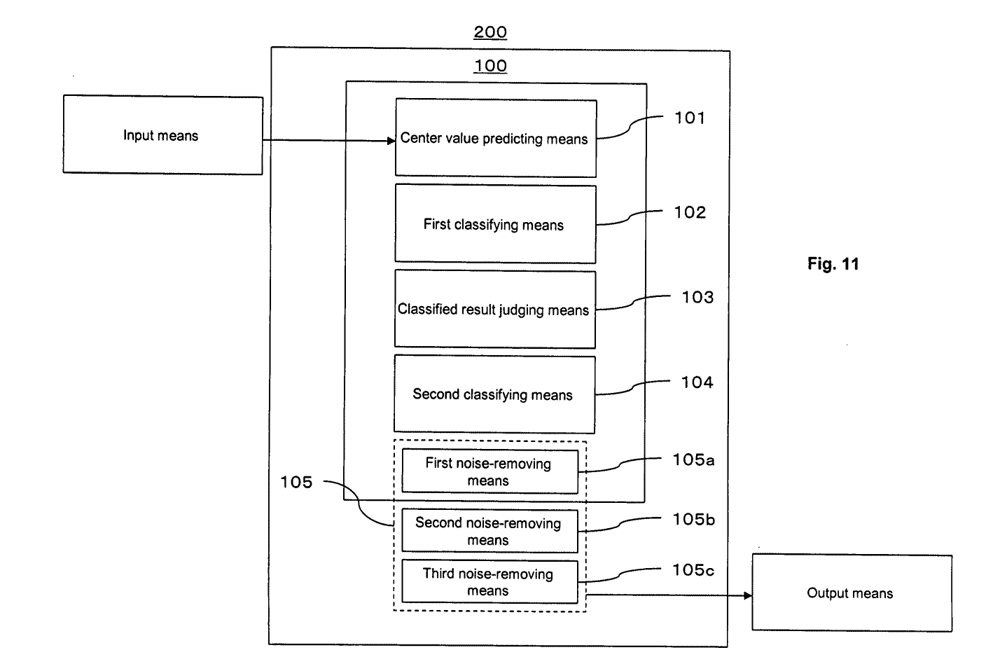

FIG. 12 It is a flowchart showing the movement of the clustering system in the above embodiment.

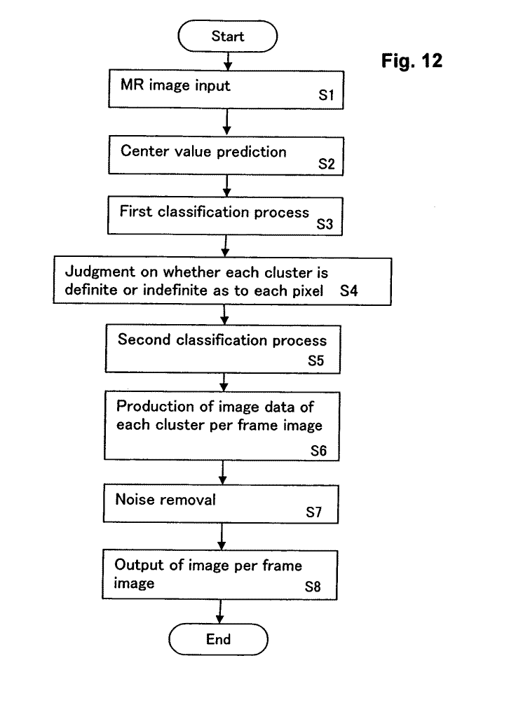

FIG. 13 It shows examples of a histogram (a) of a sheet of frame image and a histogram (b) of the total of 124 sheets of frame images.

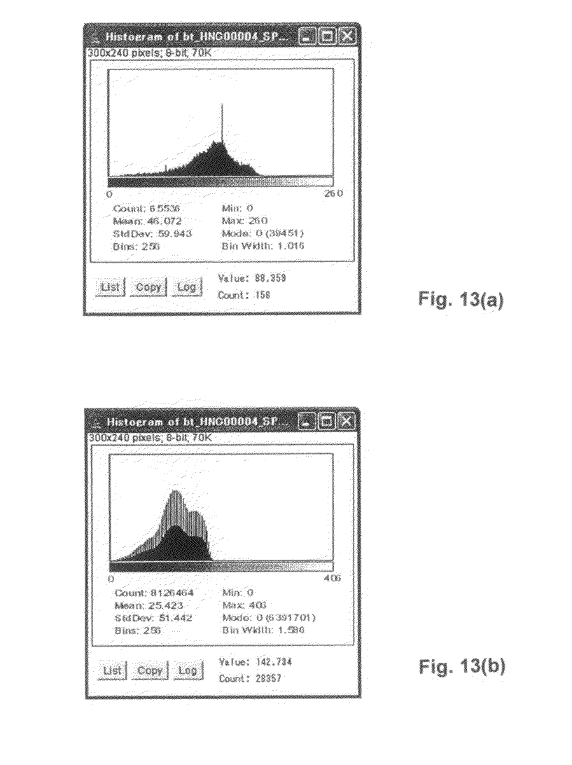

FIG. 14 It is a flowchart illustrating the movement of the first classifying means.

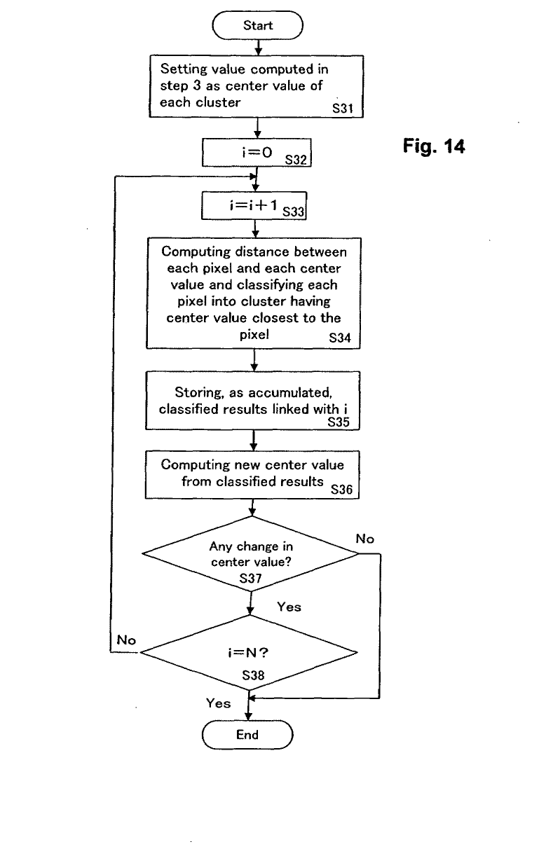

FIG. 15 It is a flowchart illustrating the movement of the second classifying means.

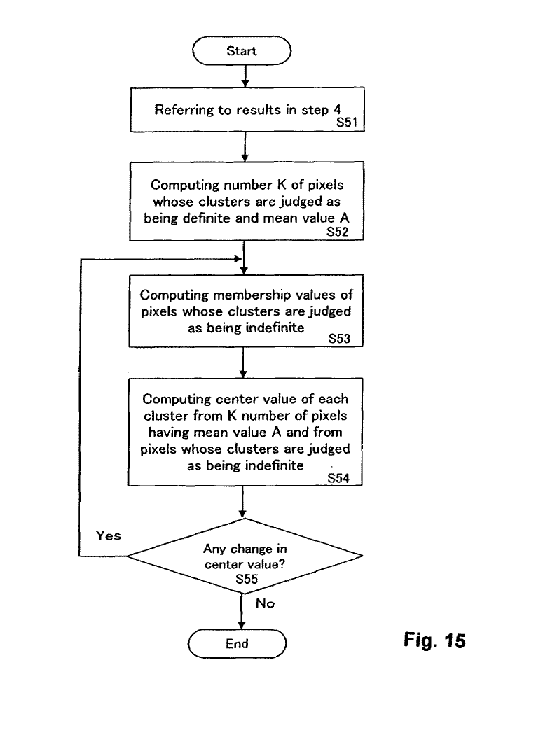

FIG. 16 It is a diagram having visualized the image data obtained.

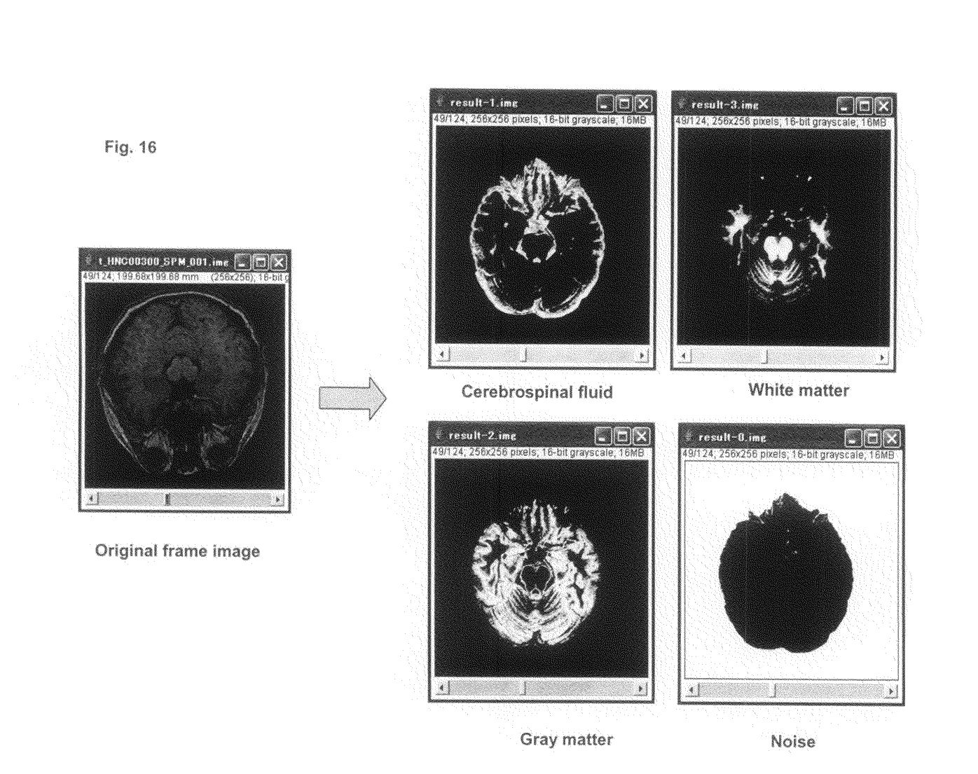

FIG. 17 It is an explanatory view illustrating a method of determining a intensity value based on the membership value.

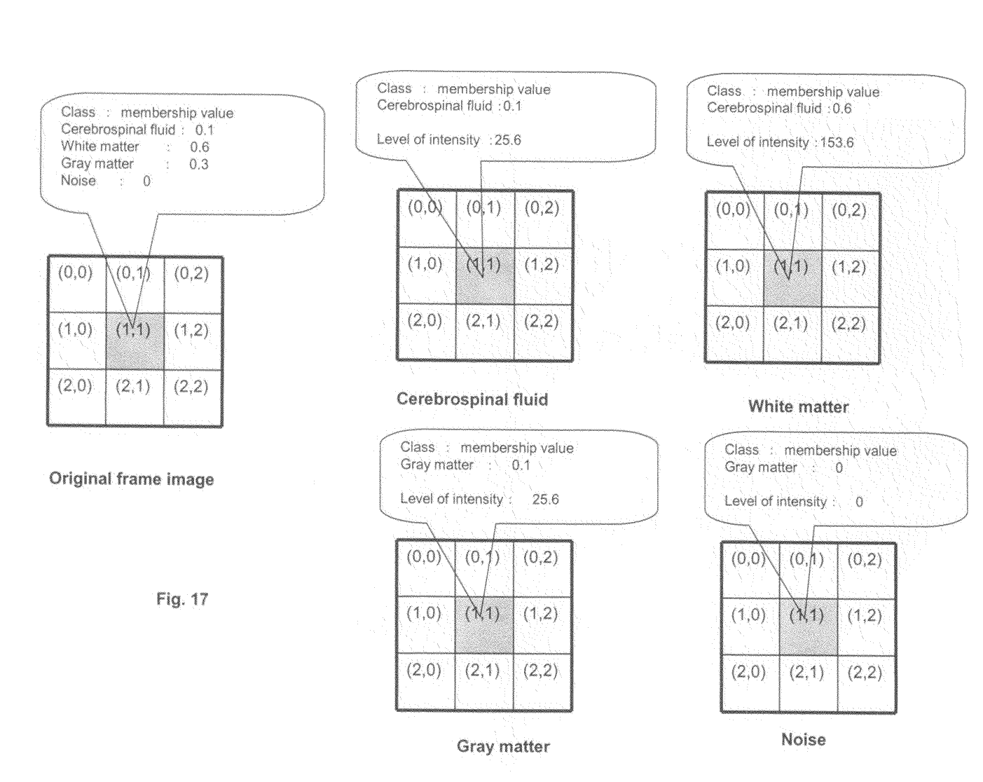

FIG. 18 It is a diagram having visualized the image data having colored the element judged as noise.

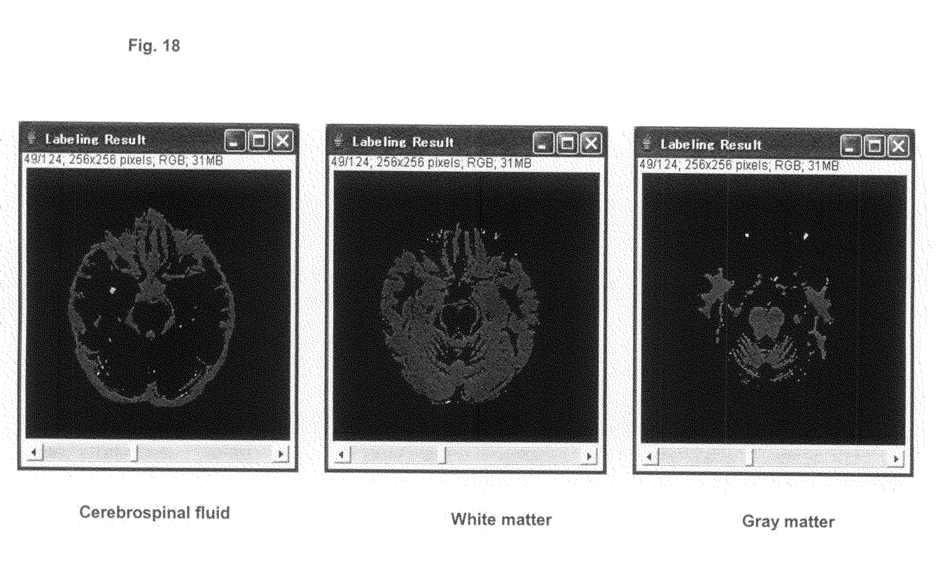

FIG. 19 It is a diagram showing an example of the image data displayed on request.

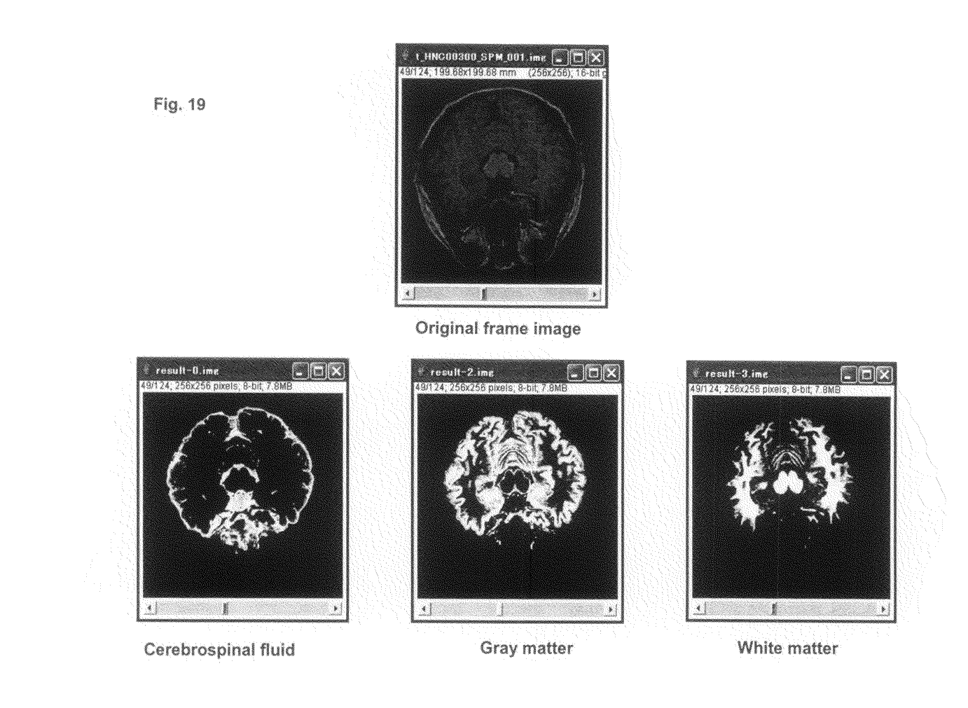

FIG. 20 It is a schematic block diagram functionally showing the image processing system equipped with the clustering system according to the third embodiment.

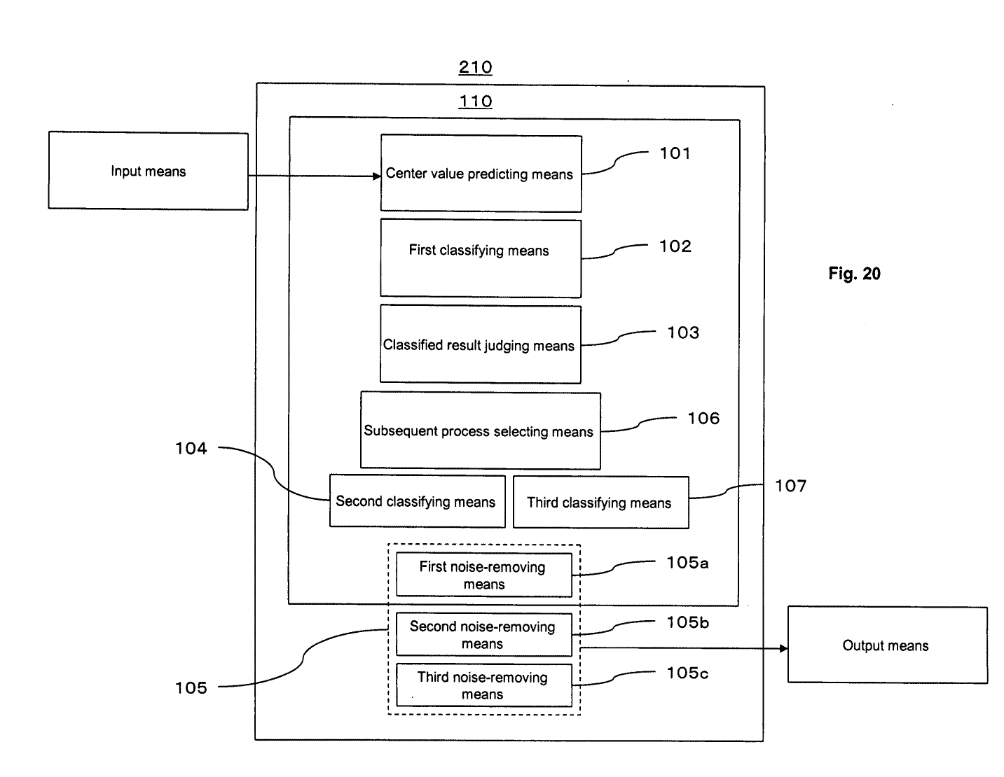

FIG. 21 It is a flowchart illustrating the movement of the image processing system equipped with the clustering system in the above embodiment.

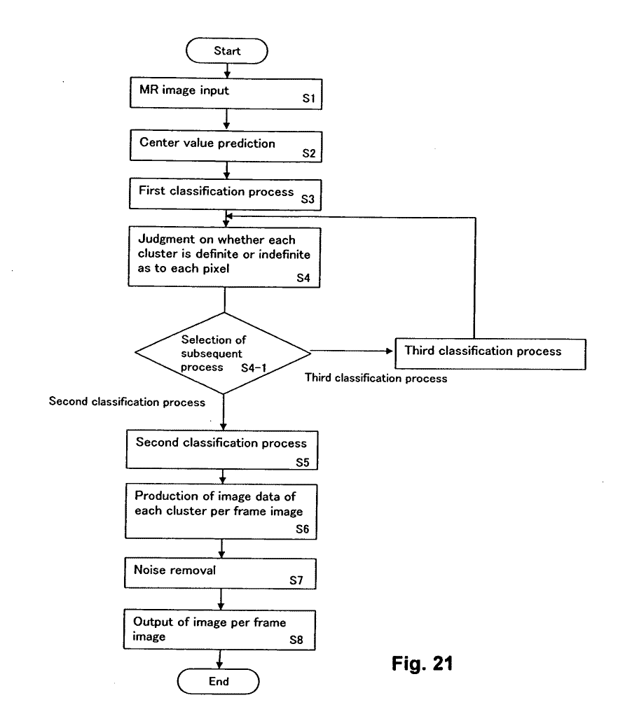

FIG. 22 It is a flowchart illustrating the movement of the third classifying means.

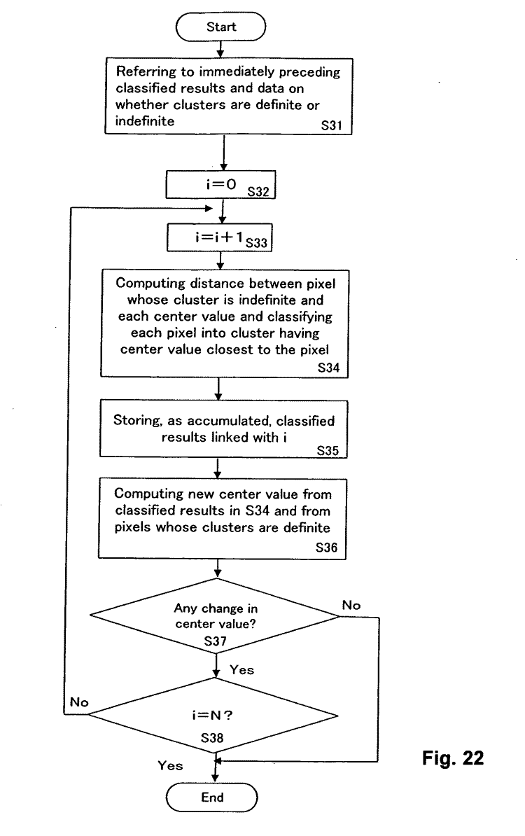

FIG. 23 It is an explanatory view illustrating the C-Means method as one example of the clustering technology.

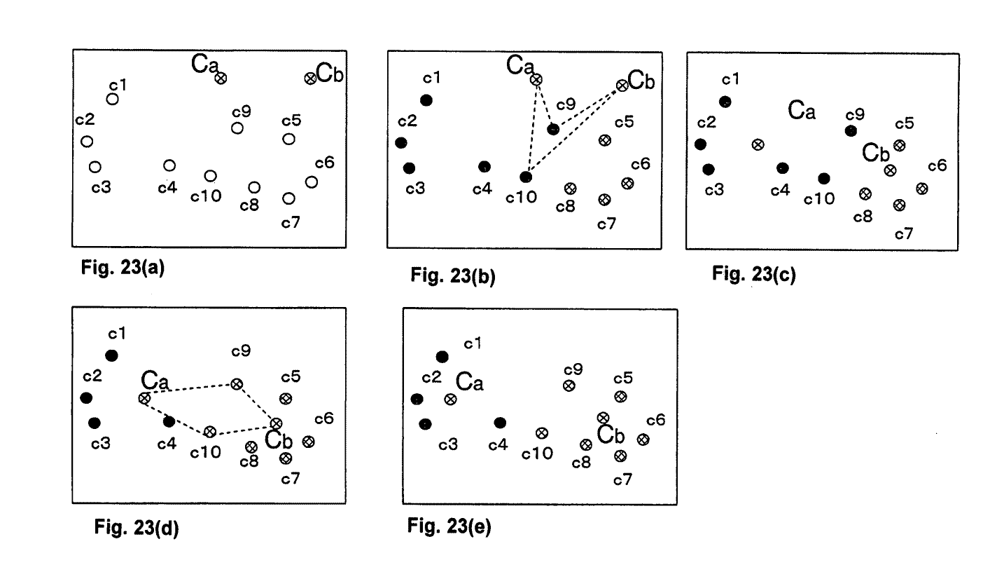

FIG. 24 It is an explanatory view illustrating the FCM method as another example of the clustering technology.

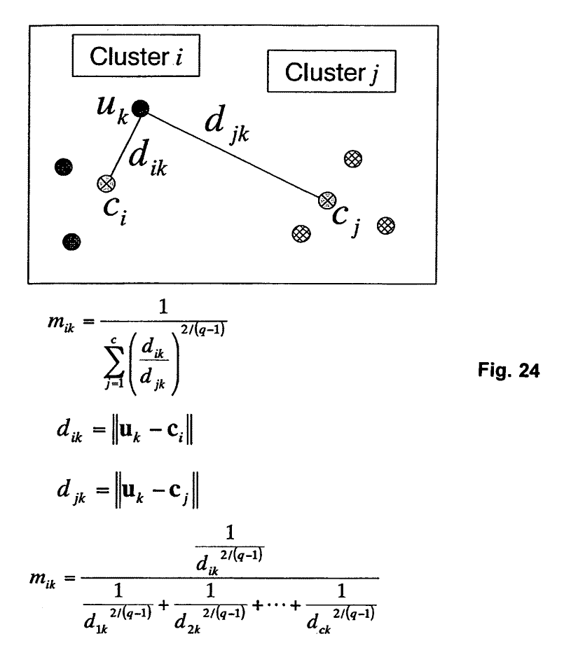

### DESCRIPTION OF REFERENCE NUMERALS

100, 110 Clustering systems
200, 210 Image processing systems
101 Center value predicting means
102 First classifying means
103 Classification result judging means
104 Second classifying means
105 Noise removing means
106 Subsequent process selecting means
107 Third classifying means
f Frame image

1. A clustering system for clustering plural elements, comprising computing center values of clusters and distances between the center values of the clusters and the elements, performing plural classification processes for classifying the elements into relevant clusters based on the distances, wherein the clustering system includes judging means for making judgments on whether the relevant clusters into which the elements have been classified are definite or indefinite at one or plural timings between adjacent classification processes and classifies only elements judged as being indefinite in the classification processes performed subsequent to the judgments.

2. A clustering system according to claim 1, wherein the classification processes performed before the judgment made by the judging means at the one timing or a final timing of the plural timings are those by the C-Means method, and the classification processes after the judgment are those by the FCM method.

3. A clustering system according to claim 2, wherein in the classification processes by the C-Means method, the elements are classified into the clusters so that a ratio of intercluster variance to intracluster variance becomes maximal and a mean value of the elements in each cluster is regarded as a center value of each cluster.

4. A clustering system according to claim 1, wherein the judging means judges that a same cluster into which the elements are classified threshold times or more in the classification processes performed before the judgment is definite and that other clusters are indefinite.

5. A clustering system according to claim 1, further comprising counting means for counting the number of the elements classified into a same cluster as a cluster into which the elements are classified in a preceding classification process and wherein the judging means judges that the same cluster is definite at a timing the counted number shows no change or a decrease and that other clusters are indefinite.

6. An image processing system equipped with the clustering system for clustering plural elements, comprising computing center values of clusters and distances between the center values of the clusters and the elements, performing plural classification processes for classifying the elements into relevant clusters based on the distances, wherein the clustering system includes judging means for making judgments on whether the relevant clusters into which the elements have been classified are definite or indefinite at one or plural timings between adjacent classification processes and classifies only elements judged as being indefinite in the classification processes performed subsequent to the judgments, wherein the elements are pixels constituting an image and the image is segmented in region, with the clusters as different regions.

7. An image processing system according to claim 6, wherein part of each region, in which more than a prescribed number of the pixels are not continuously arrayed after the image is segmented in region, is removed from the region.

8. An image processing system according to claim 6, wherein the image comprises plural images having spatial and temporal orders and, when more than a prescribed number of corresponding pixels are not continuously arrayed between adjacent images in each region after each image is segmented in region, the pixels are removed from the region.
